(19) United States
(12) Patent Application Publication
(10) Pub. No.: US 2007/0288859 A1
(43) Pub. Date: Dec. 13, 2007

(54) Method and apparatus for selective forwarding of e-mail and document content

(75) Inventors: John Vuong, San Jose, CA (US); Sarah Korah, San Jose, CA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Communications, Inc.

(21) Appl. No.: 11/449,221

(22) Filed: Jun. 7, 2006

(51) Int. Cl. G06F 3/048

(52) U.S. Cl. 715/770; 715/769; 715/808; 715/781

(57) ABSTRACT

A telecommunications method includes selecting and copying a portion of a document; detecting said selecting and copying; and automatically generating an e-mail editing window responsive to said detecting and pasting said portion into said e-mail editing window. In some embodiments, a method further includes generating a dialog after said detecting for providing an option to deselect the automatically generating option. In some embodiments, the selecting and copying includes selecting and copying using a cursor pointing device. In some embodiments, generating a dialog includes selecting a dialog option using a cursor pointing device

### BACKGROUND OF THE INVENTION

1. Field of the Invention

The present invention relates to telecommunications systems and, in particular, to an improved electronic mail system.

2. Description of the Related Art

Electronic mail, or e-mail, systems allow users to forward an e-mail message, typically by clicking a “Forward” button on a graphical user interface. The system responds by generating a new e-mail message window and copying the entirety of the to-be-forwarded message into the new window.

Often the message to be forwarded includes a significant amount of extraneous material that the sender does not wish forwarded. This can be particularly onerous and error-prone when the to-be-forwarded message itself has been forwarded one or more times. In this case, a significant amount of extraneous header and footer information may be included. To remove such material, the user must manually select the undesired portions and delete them.

Similarly, when a user wishes to e-mail a document, such as a word processing or spreadsheet document, the user opens an e-mail window and typically clicks a “Attach” control button. This opens a dialog that lets the user attach the document to the e-mail. However, if the user wishes to e-mail only a portion of the document, he must first open the document in a word processing program and edit it appropriately, then save the edits as a new document. The new document can then be forwarded in a conventional manner. Again, this can be relatively onerous and error-prone.

### SUMMARY OF THE INVENTION

These and other drawbacks in the prior art are overcome in large part by a system and method according to embodiments of the present invention.

A telecommunications method according to an embodiment of the present invention includes selecting and copying a portion of a document; detecting said selecting and copying; and automatically generating an e-mail editing window responsive to said detecting and pasting said portion into said e-mail editing window. In some embodiments, a method further includes generating a dialog after said detecting for providing an option to deselect the automatically generating option. In some embodiments, the selecting and copying includes selecting and copying using a cursor pointing device. In some embodiments, generating a dialog includes selecting a dialog option using a cursor pointing device.

A processing device according to another embodiment of the present invention includes a processor; and a memory operably coupled to the processor storing code executable by the processor for selecting and copying a portion of a document to a clipboard memory; detecting said selecting and copying; and automatically generating an e-mail editing window responsive to said detecting and pasting said portion into said e-mail editing window. In some embodiments, the code executable by the processor includes code for generating a dialog after said detecting for providing an option to deselect the automatically generating option. In some embodiments, the selecting and copying includes selecting and copying using a cursor pointing device. In some embodiments, the generating a dialog includes selecting a dialog option using a cursor pointing device. In some embodiments, the document is an e-mail document. In some embodiments, the document is a word processing document.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a diagram illustrating a system according to embodiments of the present invention.

FIG. 2 is a diagram illustrating a network according to embodiments of the present invention.

FIG. 3 is a diagram schematically illustrating operation of embodiments of the present invention.

FIG. 4A and FIG. 4B are flowcharts illustrating operation of embodiments of the present invention.

FIG. 5 is a diagram schematically illustrating operation of embodiments of the present invention.

FIG. 6A and FIG. 6B are flowcharts illustrating operation of embodiments of the present invention.

FIG. 7 is a diagram schematically illustrating operation of embodiments of the present invention.

FIG. 8A and FIG. 8B are flowcharts illustrating operation of embodiments of the present invention.

FIG. 9 is a block diagram of a user device according to embodiments of the present invention.

### DETAILED DESCRIPTION OF EMBODIMENTS OF THE INVENTION

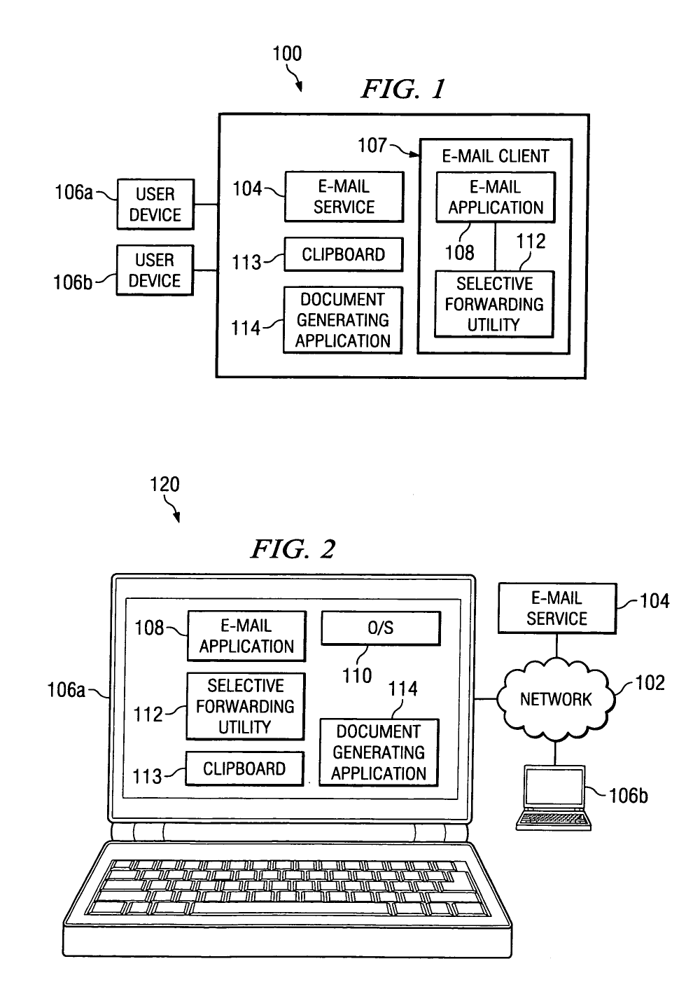

Turning now to the drawings and, with particular attention to FIG. 1, a diagram of a telecommunications system 100 according to an embodiment of the present invention is shown. In the embodiment illustrated, the system includes an e-mail service 104 connected to or in communication with an e-mail client 107 and a document generating application 114. The e-mail client may include an e-mail application program 108 and a selective forwarding utility 112 in accordance with embodiments of the present invention.

User devices, such as user devices 106a, 106b may be connected to or in communication with the e-mail service 104. In certain embodiments, the user devices may be implemented as telephones, cellular telephones, PDAs, computers, etc. For example, a user device 106a, 106b may be embodied as a personal computer implementing the Windows XP operating system.

In certain embodiments, the system 100 may also include other hardware and/or software components (e.g., gateways, proxy servers, registration server, presence servers, redirect servers, databases, applications, etc.) such as, for example, hardware and software used to support a SIP (Session Initiation Protocol) or other protocol based infrastructure for the system 100 and allow the registration of SIP devices in the system 100.

The e-mail service 104 may be or include an application that allows users to register and make use of Internet electronic mail services. The e-mail service 104 may be implemented in hardware and/or software operating on one or more servers, computer systems, host or mainframe computers, workstations, etc. In some embodiments, the e-mail service 104 may be operating on some or all of the same devices as other components in the system 100.

The e-mail service 104 may couple to or be in communication with, one or more e-mail clients 107 that allow users to compose, save, etc., e-mail. The e-mail clients 107 may include e-mail application programs 108 and selective forwarding utilities 112 in accordance with embodiments of the present invention. More particularly, as will be explained in greater detail below, the selective forwarding utilities operate in conjunction with the e-mail application programs 108 and/or the document generating application program 114 to allow selection of portions of documents and automatically generate an e-mail therefrom. The e-mail client 107 may be implemented in hardware and/or software operating on one or more servers, computer systems, host or mainframe computers, workstations, etc. In some embodiments, the e-mail client 107 may be operating on some or all of the same devices as other components in the system 100.

As noted above, the e-mail clients 107 may interact with one or more document generating application programs 114. Such document generating application programs 114 may include word processing programs, such as Microsoft Word; spreadsheet programs, such as Microsoft Excel; or any program that allows for generating documents. The document generating application programs 114 may be implemented in hardware and/or software operating on one or more servers, computer systems, host or mainframe computers, workstations, etc. In some embodiments, the document generating application programs 114 may be operating on some or all of the same devices as other components in the system 100.

In certain embodiments of the present invention, one or more of the components of the system 100 may be connected to or in communication with each other via a communication network. For example, turning now to FIG. 2, a system 120 including the components of the system 100 is illustrated, wherein some or all of the components are in communication via a network 102. The network 102 may be or include the Internet, World Wide Web, a local area network, or some other public or private computer, cable, telephone, client/server, peer-to-peer, or communication network or intranet. In some embodiments, the communication network can also include other public and/or private wide area networks, local area networks, wireless networks, data communications networks, or connections, intranets, routers, satellite links, microwave links, cellular or telephone networks, radio links, fiber optic transmission lines, ISDN lines, T1 lines, DSL connections, etc. Moreover, as used herein, communications include those enabled by wired or wireless technology. In some embodiments, some or all of the network 102 may be implemented using a TCP/IP network and may implement voice or multimedia over IP using, for example, the Session Initiation Protocol (SIP).

In the particular implementation illustrated, the e-mail client 107 and the document generating application program 114 may run on one of the user devices, such as a personal computer 106a. In addition, the user devices 106a, 106b may include an operating system/graphical user interface program 110 such as Microsoft Windows XP; and a clipboard memory 113. The clipboard memory 113 is a portion of memory set aside for temporarily storing portions of documents that have been selected by the user.

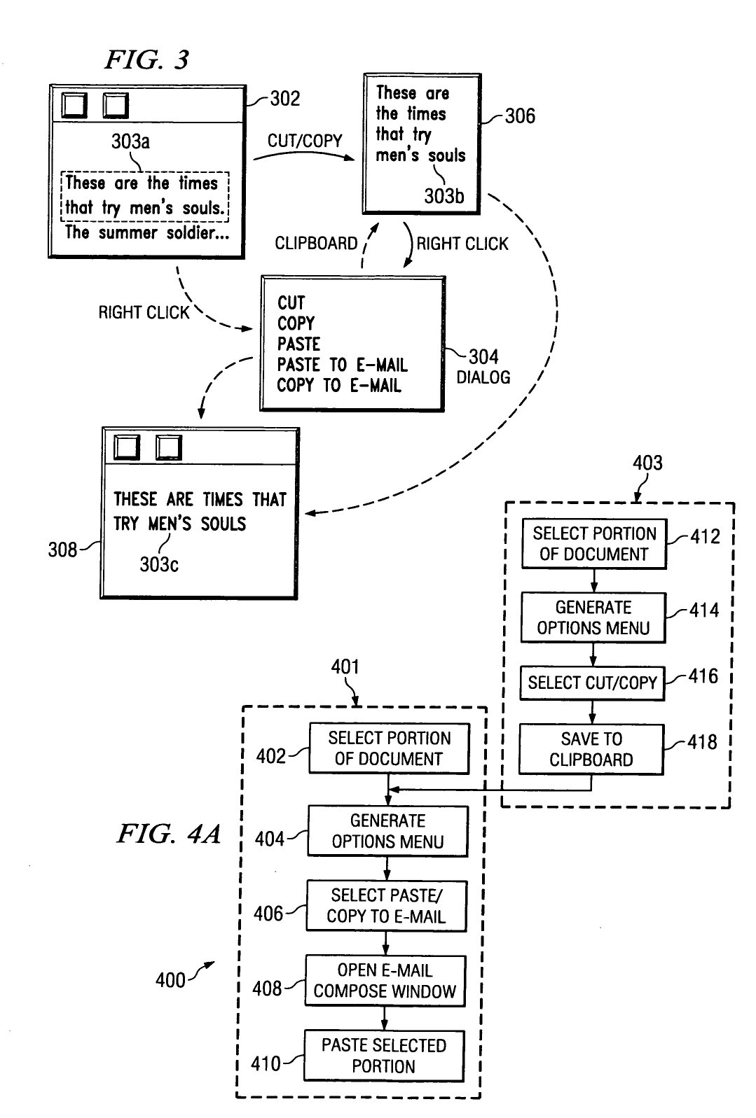

Turning now to FIG. 3, a diagram illustrating operation of an embodiment of the present invention is shown. In particular, FIG. 3 illustrates selectively copying portions of a document to an e-mail according to embodiments of the present invention.

Shown is an exemplary document window 302. The document window 302 may be representative of an e-mail window, a word processing document window, a spreadsheet document window, or other document window in which a user can select text or other information. The window can include a variety of text or information. As shown, a user can “select” or “highlight” portions 303a of the text, for example, by manipulating the left key of a mouse (not shown) or other cursor pointing device. Once the user has selected the text, for example, text 303a, the user can “right click” to reveal an options dialog menu such as menu 304. In the example, illustrated, menu options include CUT, COPY, PASTE, PASTE TO EMAIL, and COPY TO EMAIL.

In general, if the user selects CUT or COPY, the selected text will be transferred to a clipboard memory 113 as shown at 306. The selected text 303a is detected as present in the clipboard 113 and is then available to be inserted into another document, typically, via selection of PASTE from the menu 304.

According to embodiments of the present invention, however, the user may have the option of selecting PASTE TO EMAIL. According to embodiments of the present invention, this causes the e-mail program 108 to generate a new e-mail document or “compose” window, and automatically pastes the text from the clipboard into the new e-mail window, as shown at 308.

According to other embodiments of the present invention, instead of separately cutting/copying and then pasting to e-mail, the user can select COPY TO EMAIL from the menu 304. Again, this causes the e-mail program 108 to generate a new compose window and automatically pastes the selected text into the new compose window. Depending on the specific implementation, the text can also be copied into the clipboard 113 for other use.

It is noted that in certain embodiments (particularly those in which the original document is an e-mail), merely selecting the text may itself automatically cause generation of a new e-mail compose window. Alternatively, selecting the text can generate a new dialog window that asks if the user wishes to paste into a new e-mail. If the user selects YES, a new compose window is generated. In addition, in certain embodiments, a dialog may be generated allowing the user to deselect the automatic paste to e-mail option.

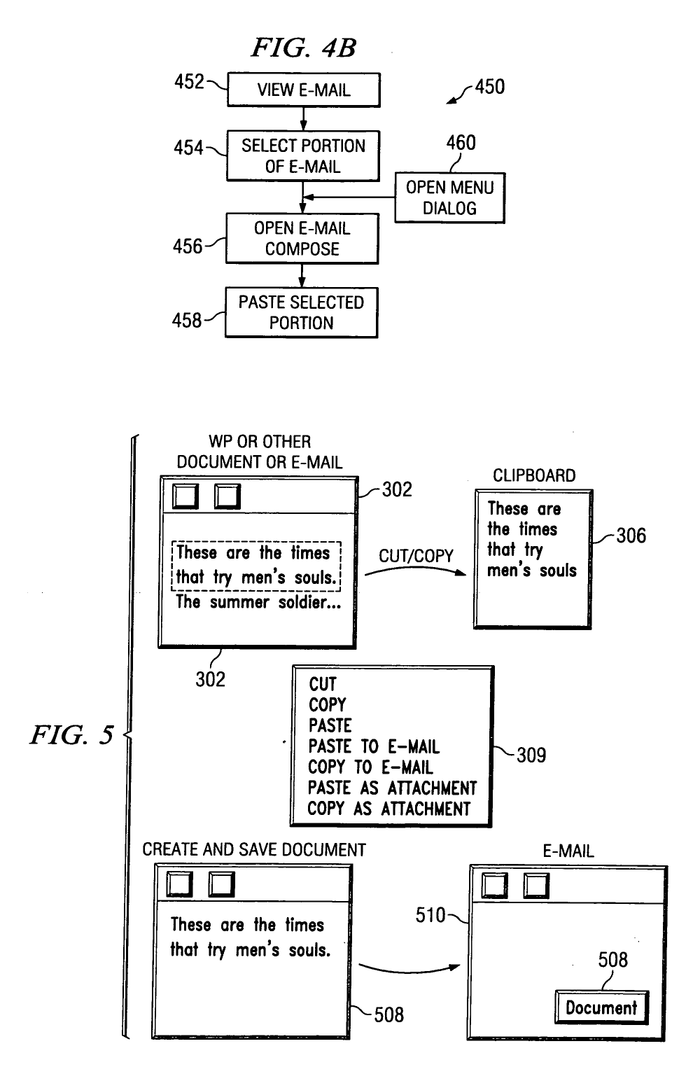

Turning now to FIG. 4A, a flowchart 400 illustrating operation of embodiment of the present invention is shown. The particular arrangement of elements in the flowchart 400 is not meant to imply a fixed order to the elements; embodiments can be practiced in any order that is practicable.

In branch 401, at a step 402, a portion of a document in a document generating program 114 can be selected. As noted above, this may be done via a cursor pointing device such as a mouse, trackball, touchscreen LED, tablet, etc. At a step 404, the options dialog menu 304 is generated. In certain embodiments, the document generating program 114 can generate the options menu 304 responsive to a “right click” from the cursor pointing device. In other embodiments, the operating system generates the options menu. At a step 406, the PASTE or COPY TO E-MAIL options may be selected and/or detected. For example, the user may select and left click the appropriate menu entry, which is then detected by the selective forwarding utility 112. In response, in a step 408, the e-mail compose window 308 is opened. For example, the selective forwarding utility 112 may issue the appropriate commands to the e-mail program 108 or operating system to cause it to open. Finally, in a step 410, the selected portion of the document is pasted from the clipboard 113 into the compose e-mail window.

Branch 403 illustrates operation of an alternate embodiment of the present invention. In a step 412, a portion of a document may be selected. Again, this may be done via a cursor pointing device such as, e.g., a mouse or trackball. At a step 414, the options menu 304 is generated. In certain embodiments, the document generating program 114 can generate the options menu responsive to a “right click” from the cursor pointing device. In other embodiments, the operating system 110 generates the options menu. In a step 416, the CUT or PASTE options may be selected. For example, the user may select and left click the appropriate menu entry, which is then detected by the document generating program 114 or the operating system 110. The selection is then saved to the clipboard memory 113, in a step 418. The contents of the clipboard can be pasted into a e-mail compose window following steps 404-410, described above.

FIG. 4B is a flowchart 450 illustrating operation of another embodiment of the present invention. The particular arrangement of elements in the flowchart 450 is not meant to imply a fixed order to the elements; embodiments can be practiced in any order that is practicable.

In a step 452, a user can view a document, such as an e-mail document. In a step 454, a portion of the document can be selected and cut or copied. Again, this may be done, for example, via a cursor pointing device such as a mouse or trackball. In a step 456, the selection is detected by the selective forwarding utility 112, which causes the e-mail application 108 to open a new compose e-mail window. In a step 458, the selected portion is automatically pasted into the compose e-mail window.

In another embodiment, a menu dialog at 460 may be opened to query whether the user wants to paste to e-mail; if the user clicks yes, then steps 456 and 458 may be undertaken. It is noted that, as in the previously discussed embodiments, the document may be a document from a program other than an e-mail program. Thus, the figure is exemplary only.

Turning now to FIG. 5, a diagram illustrating operation of another embodiment of the present invention is shown. In particular, in FIG. 5, the highlighted or selected portions of a document may be attached to an e-mail as an attachment, rather than “in line.” Shown in FIG. 5 is window 302, clipboard with selected content 306, similar to those of FIG. 3.

Also shown is an option menu 309 that functions in a manner generally similar to that of FIG. 3. However, options menu 309 includes PASTE AS ATTACHMENT and COPY AS ATTACHMENT options. In this embodiment, the user can select PASTE AS ATTACHMENT for material that is present in the clipboard 306; the e-mail program 108 will then open a new e-mail compose window 510 and attach the material as a file 508 to the e-mail Typically, the file is attached in a same file format as the original document, although in certain embodiments, a default file type may be used, or a user may select a document type. These can include, but are not limited to, for example, *.doc, *.txt, *.pdf, *.ppt, etc., document types.

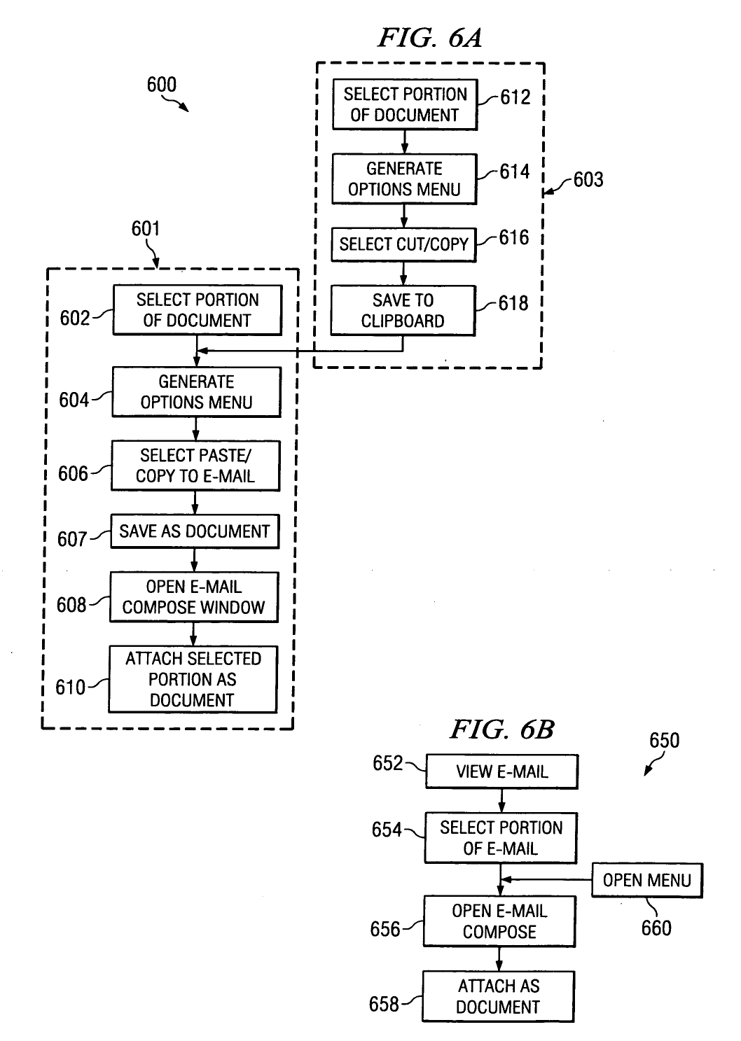

Turning now to FIG. 6A, a flowchart 600 illustrating operation of embodiment of the present invention is shown. The particular arrangement of elements in the flowchart 600 is not meant to imply a fixed order to the elements; embodiments can be practiced in any order that is practicable.

In branch 601, at a step 602, a portion of a document in a document generating or reading program can be selected. As noted above, this may be done via a cursor pointing device such as a mouse or trackball. At a step 604, the options menu 309 is generated. In certain embodiments, the document generating program 114 can generate the options menu responsive to a “right click” from the cursor pointing device. In other embodiments, the operating system 110 generates the options menu 309. At a step 606, the PASTE or COPY AS ATTACHMENT TO EMAIL options may be selected and/or detected. For example, the user may select and left click the appropriate menu entry, which is then detected by the selective forwarding utility 112. In a step 607, if the user selected the “attachment” option, the user may be given the option of saving the selected portion into a document, of the same type as the source of the selection. The system can identify the source document and source document generating program and the document can be given a default name and a storage location. Alternatively, the user may specify a document name and storage location. In a step 608, an e-mail compose window may be opened in a manner similar to that discussed above. In a step 610, the document is attached to the new e-mail.

It is noted that, in alternate embodiments, rather than providing the user the saving option in step 607, the system could automatically generate the document, giving it a default name, in step 610, just prior to attachment.

Branch 603 illustrates operation of an alternate embodiment of the present invention. In a step 612, a portion of a document may be selected. Again, this may be done via a cursor pointing device such as a mouse or trackball. At a step 614, the options menu is generated. In certain embodiments, the document generating program 114 can generate the options menu responsive to a “right click” from the cursor pointing device. In other embodiments, the operating system 110 generates the options menu. In a step 618, the CUT or PASTE options may be selected. For example, the user may select and left click the appropriate menu entry, which is then detected by the document generating program or the operating system. The selection is then saved to the clipboard memory 113, in a step 618. The contents of the clipboard can be attached to a e-mail compose window following steps 606-610, described above.

FIG. 6B is a flowchart 650 illustrating operation of another embodiment of the present invention. The particular arrangement of elements in the flowchart 650 is not meant to imply a fixed order to the elements; embodiments can be practiced in any order that is practicable.

In a step 652, a user can view a document, such as an e-mail document. In a step 654, a portion of the document can be selected and cut or copied. Again, this may be done, for example, via a cursor pointing device such as a mouse or trackball. In a step 656, the selection is detected by the selective forwarding utility 112, which causes the e-mail application 108 to open a new compose e-mail window. In a step 658, the selected portion is automatically attached to the compose e-mail window. That is, it can be automatically inserted or pasted into a document, given a default name and type, and be automatically attached.

In another embodiment, a menu dialog at 660 may be opened to query whether the user wants to paste to e-mail; if the user clicks yes, then steps 656 and 658 may be undertaken. It is noted that, as in the previously discussed embodiments, the document may be a document from a program other than an e-mail program. Thus, the figure is exemplary only.

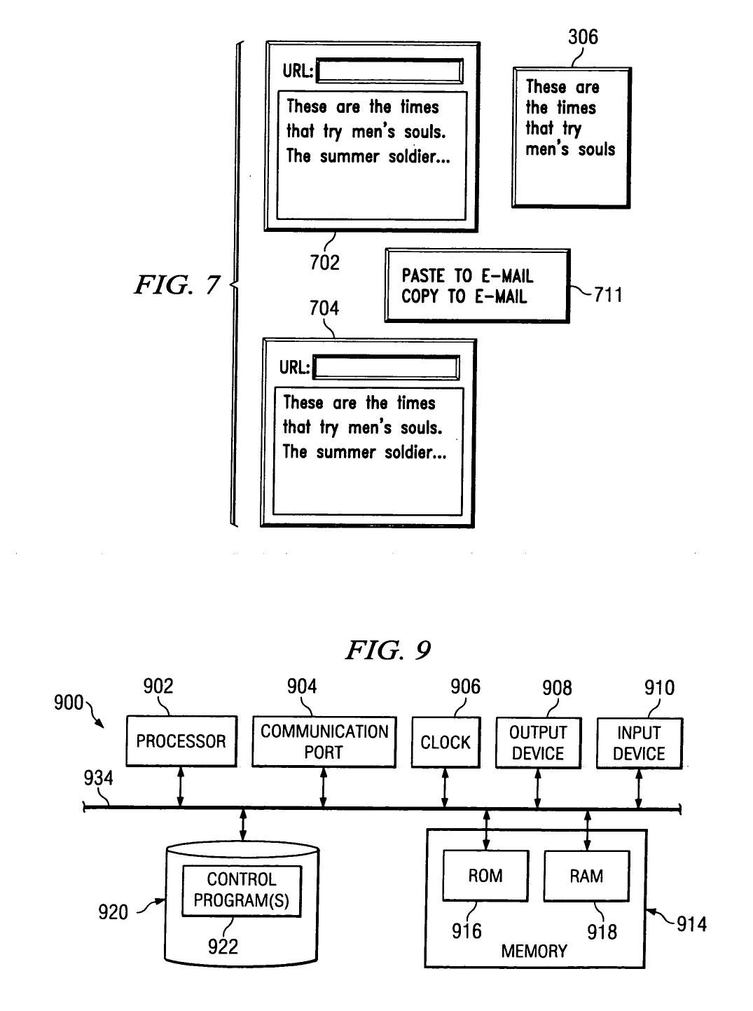

Embodiments of the present invention may be used in conjunction with a web e-mail system, as well as to standard e-mail. In this case, the e-mail server of FIG. 3 may be embodied as a web server. FIG. 7 schematically illustrates operation of such an embodiment. Shown in FIG. 7 is an exemplary document window 702, such as a web browser window open to an URL that supports web e-mail composition. Again, the user may select text or other portions of the relevant document, and right click for menu 711.

In this case, selecting the PASTE or COPY EMAIL (or attachment) options results in either the generation of a new web browser window at the appropriate URL, or a navigation from the current window to the compose window URL, and the pasting of the selected text in or attaching the text to window 704.

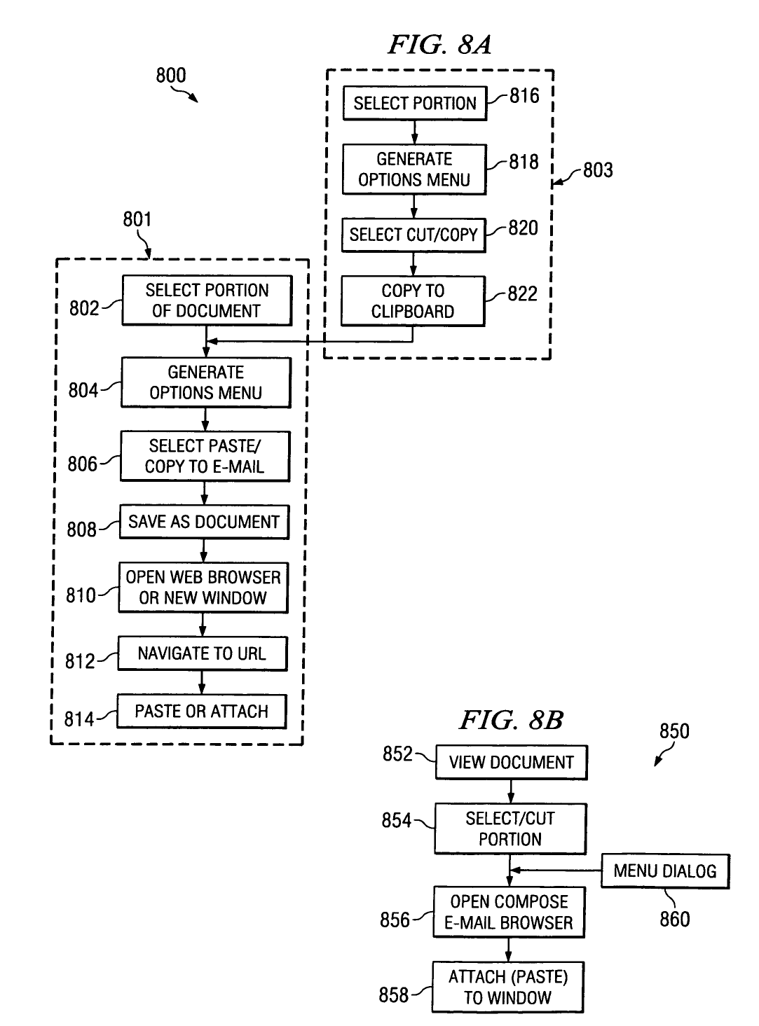

Turning now to FIG. 8A, a flowchart 800 illustrating operation of embodiment of the present invention is shown. The particular arrangement of elements in the flowchart 800 is not meant to imply a fixed order to the elements; embodiments can be practiced in any order that is practicable.

In branch 801, at a step 802, a portion of a document in a document generating or reading program can be selected. As noted above, this may be done via a cursor pointing device such as a mouse or trackball. At a step 804, the options dialog menu is generated. In certain embodiments, the document generating program 114 can generate the options menu responsive to a “right click” from the cursor pointing device. In other embodiments, the operating system 110 generates the options dialog menu. At a step 808, the PASTE or COPY TO E-MAIL options may be selected and/or detected. For example, the user may select and left click the appropriate menu entry, which is then detected by the selective forwarding utility 112. In a step 808, the user may be given the option of saving the selected portion into a document, of the same type as the source of the selection (particularly in the case that the attachment option has been selected). The system can identify the source document and source document generating program and the document can be given a default name and storage location. Alternatively, the user may specify a document name and storage location. In a step 810, the web browser may be opened or a new browser window may be opened. For example, in a manner similar to that discussed above, the selective forwarding utility 112 may issue the appropriate commands to the web browser or operating system to cause it to open. In a step 812, the browser navigates or opens to the URL of the compose e-mail page. Finally, in a step 814, the document is attached or pasted to the new e-mail. It is noted that, in alternate embodiments, rather than providing the user the option in step 808, the system could automatically generate the document, giving it a default name, in step 814, just prior to attachment.

Branch 803 illustrates operation of an alternate embodiment of the present invention. In a step 816, a portion of a document may be selected. Again, this may be done via a cursor pointing device such as a mouse or trackball. At a step 818, the options dialog menu is generated. In certain embodiments, the document generating program 112 can generate the options menu responsive to a “right click” from the cursor pointing device. In other embodiments, the operating system generates the options menu. In a step 820, the CUT or PASTE options may be selected. For example, the user may select and left click the appropriate menu entry, which is then detected by the document generating program 112 or the operating system 110. The selection is then saved to the clipboard memory 113, in a step 822. The contents of the clipboard 113 can be attached to a e-mail compose window following steps 804-814, described above.

FIG. 8B is a flowchart 850 illustrating operation of another embodiment of the present invention. The particular arrangement of elements in the flowchart 850 is not meant to imply a fixed order to the elements; embodiments can be practiced in any order that is practicable.

In a step 852, a user can view a document, such as an e-mail document in a web browser. In a step 854, a portion of the document can be selected and cut or copied. Again, this may be done, for example, via a cursor pointing device such as a mouse, trackball, or other device. In a step 856, the selection is detected by the selective forwarding utility 112, which causes the e-mail application 108 to open a new browser window compose e-mail window. In a step 858, the selected portion is automatically attached the compose e-mail window.

In another embodiment, a menu dialog at 880 may be opened to query whether the user wants to paste to e-mail; if the user clicks yes, then steps 856 and 858 may be undertaken. It is noted that, as in the previously discussed embodiments, the document may be a document from a program other than an e-mail program. Thus, the figure is exemplary only.

Now referring to FIG. 9, a representative block diagram of a computer or processing device 900 suitable for use as a user device or server according to embodiments of the present invention is shown. In some embodiments, the computer 900 may include or operate an e-mail client, operating system, selective forwarding utility, clipboard memory, web browser, and document generating program. The computer 900 may be embodied as a single device or computer, a networked set or group of devices or computers, a workstation, mainframe or host computer, etc. In some embodiments, the computer 900 may implement one more elements of the methods disclosed herein.

The computer 900 may include a processor, microchip, central processing unit, or computer 902 that is in communication with or otherwise uses or includes one or more communication ports or network interfaces 904 for communicating with user devices and/or other devices. The communication ports 904 may include such things as local area network adapters, wireless communication devices, Bluetooth technology, cellular network interfaces, etc. The computer 900 also may include an internal clock element 906 to maintain an accurate time and date for the computer 900, create time stamps for communications received or sent by the computer 900, etc.

If desired, the computer 900 may include one or more output devices 908 such as a printer, infrared or other transmitter, antenna, audio speaker, display screen or monitor, text to speech converter, etc. as well as one or more input devices 910 such as a bar code reader or other optical scanner, infrared or other receiver, antenna, magnetic stripe reader, image scanner, roller ball, touch pad, joystick, touch screen, microphone, computer keyboard, computer mouse, etc.

In addition to the above, the computer 900 may include a memory or data storage device 920 to store information, software, databases, documents, communications, device drivers, etc. The memory or data storage device 920 may be implemented as an appropriate combination of magnetic, optical and/or semiconductor memory, and may include, for example, Read-Only Memory (ROM), Random Access Memory (RAM), a tape drive, flash memory, a floppy disk drive, a Zip™ disk drive, a compact disc and/or a hard disk. Thus, the storage device 920 may include various combinations of moveable and fixed storage. The computer 900 also may include memory 914, such as ROM 916 and RAM 918.

The processor 902 and the data storage device 912 in the computer 900 each may be, for example: (i) located entirely within a single computer or other computing device; or (ii) connected to each other by a remote communication medium, such as a serial port cable, telephone line or radio frequency transceiver. In one embodiment, the computer 900 may be implemented as one or more computers that are connected to a remote server computer, as will be explained in greater detail below.

A conventional personal computer or workstation with sufficient memory and processing capability may be used as the computer 900. The computer 900 may be capable of high volume transaction processing, performing a significant number of mathematical calculations in processing communications and database searches. A Pentium™ microprocessor such as the Pentium III™ or IV™ microprocessor, manufactured by Intel Corporation may be-used for the processor 902. Other suitable processors may be available from Motorola, Inc., AMD, or Sun Microsystems, Inc. The processor 902 also may be embodied as one or more microprocessors, computers, computer systems, etc.

Software may be resident and operating or operational on the computer 900. The software may be stored on the data storage device 920 and may include one or more control programs 922. In the client devices, the control programs 922 may include, inter alia, the operating system, selective forwarding utility, document generating programs, web browser, and e-mail programs.

The client control program 922 may control the processor 902. The processor 902 may perform instructions of the client control program 922, and thereby operate in accordance with the methods described in detail herein. The client control program 922 may be stored in a compressed, uncompiled and/or encrypted format. The client control program 922 furthermore may include program elements that may be necessary, such as an operating system, a database management system and device drivers for allowing the processor 902 to interface with peripheral devices, databases, etc. Appropriate program elements are known to those skilled in the art, and need not be described in detail herein.

The computer 900 also may include or store user information regarding identities, user devices, contexts, presence information, communications, etc. These may include, for example, default messages, etc. Information regarding other application program data may be stored in application databases (not shown)

According to some embodiments, the instructions of the control program may be read into a main memory from another computer-readable medium, such as from the ROM 916 to the RAM 918. Execution of sequences of the instructions in the control program causes the processor 902 to perform the process elements described herein. In alternative embodiments, hard-wired circuitry may be used in place of, or in combination with, software instructions for implementation of some or all of the methods described herein. Thus, embodiments are not limited to any specific combination of hardware and software.

The processor 902, communication ports 904, clock 906, output device 908, input device 910, data storage device 912, ROM 916 and RAM 918 may communicate or be connected directly or indirectly in a variety of ways. For example, the processor 902, communication ports 904, clock 906, output device 908, input device 910, data storage device 912, ROM 916 and RAM 918 may be connected via a bus 934.

While specific implementations and hardware/software configurations for the computer 900 have been illustrated, it should be noted that other implementations and hardware configurations are possible and that no specific implementation or hardware/software configuration is needed. Thus, not all of the components illustrated in FIG. 9 may be needed for the computer 900 implementing the methods disclosed herein.

The methods described herein may be embodied as a computer program developed using an object oriented language that allows the modeling of complex systems with modular objects to create abstractions that are representative of real world, physical objects and their interrelationships. However, it would be understood by one of ordinary skill in the art that the invention as described herein could be implemented in many different ways using a wide range of programming techniques as well as general-purpose hardware systems or dedicated controllers. In addition, in some embodiments, many, if not all, of the elements for the methods described above are optional or can be combined or performed in one or more alternative orders or sequences and the claims should not be construed as being limited to any particular order or sequence, unless specifically indicated.

Each of the methods described above can be performed on a single computer, computer system, microprocessor, etc. In addition, in some embodiments, two or more of the elements in each of the methods described above could be performed on two or more different computers, computer systems, microprocessors, etc., some or all of which may be locally or remotely configured. The methods can be implemented in any sort or implementation of computer software, program, sets of instructions, programming means, code, ASIC, or specially designed chips, logic gates, or other hardware structured to directly effect or implement such software, programs, sets of instructions, programming means or code. The computer software, program, sets of instructions or code can be storable, writeable, or savable on any computer usable or readable media or other program storage device or media such as a floppy or other magnetic or optical disk, magnetic or optical tape, CD-ROM, DVD, punch cards, paper tape, hard disk drive, Zip™ disk, flash or optical memory card, microprocessor, solid state memory device, RAM, EPROM, or ROM.

The foregoing description of the invention has been presented for purposes of illustration and description. It is not intended to be exhaustive or to limit the invention to the precise form disclosed, and modifications and variations are possible in light of the above teachings or may be acquired from practice of the invention. The drawings and description were chosen in order to explain the principles of the invention and its practical application. The drawings are not necessarily to scale and illustrate the device in schematic block format. It is intended that the scope of the invention be defined by the claims appended hereto, and their equivalents

What is claimed is:

1. A method, comprising:
selecting and copying a portion of a document;
detecting said selecting and copying; and
automatically generating an e-mail editing window responsive to said detecting and pasting said portion into said e-mail editing window.

2. A method in accordance with claim 1, further including generating a dialog after said detecting for providing an option to deselect the automatically generating option.

3. A method in accordance with claim 1, wherein said selecting and copying includes selecting and copying using a cursor pointing device.

4. A method in accordance with claim 2, wherein said generating a dialog includes selecting a dialog option using a cursor pointing device.

5. A method in accordance with claim 1, wherein said document is an e-mail document.

6. A method in accordance with claim 1, wherein said document is a word processing document.

7. Machine-readable media storing one or more programs and/or data for performing a method comprising:
detecting a selecting and copying of a portion of a document to a clipboard memory 113; and
automatically generating an e-mail editing window responsive to said detecting and pasting said portion into said e-mail editing window.

8. Machine-readable media storing one or more programs and/or data for performing a method in accordance with claim 7, further comprising generating a dialog after said detecting for providing an option to deselect the automatically generating option.

9. Machine-readable media storing one or more programs and/or data for performing a method in accordance with claim 7, wherein said selecting and copying includes selecting and copying using a cursor pointing device.

10. Machine-readable media storing one or more programs and/or data for performing a method in accordance with claim 8, wherein said generating a dialog includes selecting a dialog option using a cursor pointing device.

11. Machine-readable media storing one or more programs and/or data for performing a method in accordance with claim 7, wherein said document is an e-mail document.

12. Machine-readable media storing one or more programs and/or data for performing a method in accordance with claim 7, wherein said document is a word processing document.

13. A processing device, comprising:
a processor; and a memory operably coupled to the processor storing code executable by the processor for
selecting and copying a portion of a document to a clipboard memory 113;
detecting said selecting and copying; and
automatically generating an e-mail editing window responsive to said detecting and pasting said portion into said e-mail editing window

14. A processing device in accordance with claim 13, said code executable by the processor including code for generating a dialog after said detecting for providing an option to deselect the automatically generating option.

15. A processing device in accordance with claim 13, wherein said selecting and copying includes selecting and copying using a cursor pointing device.

16. A processing device in accordance with claim 14, wherein said generating a dialog includes selecting a dialog option using a cursor pointing device.

17. A processing device in accordance with claim 13, wherein said document is an e-mail document.

18. A processing device in accordance with claim 13, wherein said document is a word processing document.
